(19) United States
(12) Patent Application Publication
(10) Pub. No.: US 2026/0341544 A1
(43) Pub. Date: Oct. 29, 2026

(54) Variable-thickness debris filter for the lower end of a nuclear fuel assembly

(71) Applicant: FRAMATOME, COURBEVOIE (FR)

(72) Inventor: Eric LaBarriere, Saint-Eloi (FR)

(21) Appl. No.: 19/117,962

(22) PCT Filed: Oct. 5, 2023
(86) PCT No.: PCT/EP2023/077525

§ 371 Date: Apr. 3, 2025

(30) Foreign Application Priority Data
Oct. 7, 2022 (FR) FR2210306

(51) Int. Cl. G21C 3/32; B01D 29/00; G21C 3/33

(52) U.S. Cl. CPC G21C 3/3206; B01D 29/0097; G21C 3/3305

(57) ABSTRACT

A variable-thickness debris filter for the lower end of a nuclear fuel assembly is formed by a grid having a first face and an opposite second face. The grid has passages which extend between an inlet located on the first face and an outlet located on the second face and which allow a cooling fluid to flow through the grid. The grid has a first zone and at least one second zone in which the grid has a thickness greater than that of the grid in the first zone. Passages are present in the first zone and in each second zone.

The present disclosure relates to the field of nuclear fuel assemblies, more particularly for a Pressurized Water Reactor (PWR).

### BACKGROUND

A nuclear fuel assembly for a pressurized water nuclear reactor generally comprises a bundle of nuclear fuel rods extending along a longitudinal axis and a support skeleton configured to support the nuclear fuel rods. The support skeleton comprises a lower end-piece and an upper end-piece spaced apart along the longitudinal axis, a plurality of guide tubes extending along the longitudinal axis connecting the end-pieces to each other, and spacer grids distributed along the guide tubes and secured to the guide tubes, each spacer grid being configured to support the nuclear fuel rods.

In operation, the nuclear fuel assembly is placed vertically in a vessel of a nuclear reactor, being placed on a lower core plate provided with openings through which enters a cooling fluid which flows vertically upwards through the nuclear fuel assembly.

Debris that may be present in the coolant could damage the components of the nuclear fuel assembly.

It is possible to provide the bottom nozzle of the nuclear fuel assembly with a debris filter that allows the cooling fluid to flow while retaining any debris that may be present in the coolant. Such a debris filter is disclosed in WO2005/059923A2.

### SUMMARY

One of the goals of the present disclosure is to provide a debris filter which has limited hydraulic resistance while possessing a satisfactory debris retention capacity.

To this end, the present disclosure provides a debris filter for a lower end-piece of a nuclear fuel assembly, the debris filter being formed by a grid having a first face and an opposite second face, the grid having passages extending between an inlet located on the first face and an outlet located on the second face for the flow of a cooling fluid through the grid, the grid having a first zone and at least a second zone wherein the grid has a thickness greater than that of the grid in the first zone, passages being present in the first zone and in each second zone.

The zones of different thicknesses serve to adjust the debris retention capacity and flow resistance of the grid. A zone of greater thickness has higher retention capacity and higher flow resistance and a zone of smaller thickness has lower retention capacity and lower flow resistance.

According to particular embodiments, the debris filter comprises one or a plurality of the following optional features, taken individually or in all technically possible combinations:
each second zone has passages with an inlet and an outlet offset transversely with respect to each other;
each second zone has passages with an inlet and an outlet inclined with respect to each other with a non-zero angle of inclination;
each second zone has passages extending in a non-rectilinear manner;
the grid has in each second zone an increasing thickness from the periphery of the second zone toward the center of the second zone;
each second zone has a circular contour;
lateral walls of the passages in each second zone are higher than the lateral walls of the passages in the first zone;
at least one passage in a second zone is delimited between two opposite curved lateral walls;
the grid is formed of interlaced grid elements between which the passages are delimited, including at least one grid element of variable height extending in the first zone and at least one second zone, the height of each grid element of variable height being greater in each second zone crossed by the grid element of variable height and smaller in the first zone;
the grid has a quadrangular contour, more particularly a square contour;
the grid has four second zones;
the second zones are distributed on the grid as a matrix.

The present disclosure also provides a lower end-piece of a nuclear fuel assembly equipped with a debris filter as defined above.

The present disclosure also provides a nuclear fuel assembly, more particularly for a pressurized water nuclear reactor, comprising a debris filter as defined hereinabove.

### BRIEF SUMMARY OF THE DRAWINGS

The present disclosure and the advantages of the present disclosure will be better understood upon reading the following description, given only as a non-limiting example, and made with reference to the enclosed drawings, wherein:

FIG. 1 is a side view of a nuclear fuel assembly;

FIG. 2 is a sectional view of a lower end-piece of the nuclear fuel assembly shown in FIG. 1, fitted with a debris filter;

FIG. 3 is a top view of the debris filter;

FIG. 4 is a top view of a quadrant of the debris filter;

FIG. 5 is a perspective view of the quadrant of the debris filter illustrated in FIG. 4;

FIG. 6 is a cut perspective view of the quadrant of the debris filter illustrated in FIG. 4;

FIG. 7 is a section view of the quadrant of the debris filter illustrated in FIG. 4;

FIG. 8 is a section view similar to the view shown in FIG. 7 illustrating a debris filter according to another example of embodiment;

FIG. 9 is a partial sectional view of a debris filter according to another embodiment, illustrating two adjacent passages of the grid;

FIG. 10 is a partial top view of a debris filter according to another example of embodiment;

FIG. 11 is a section view of the debris filter shown in FIG. 10, taken along the line XI-XI in FIG. 10;

FIG. 12 is a view similar to the view shown in FIG. 11, illustrating another example of embodiment.

### DETAILED DESCRIPTION

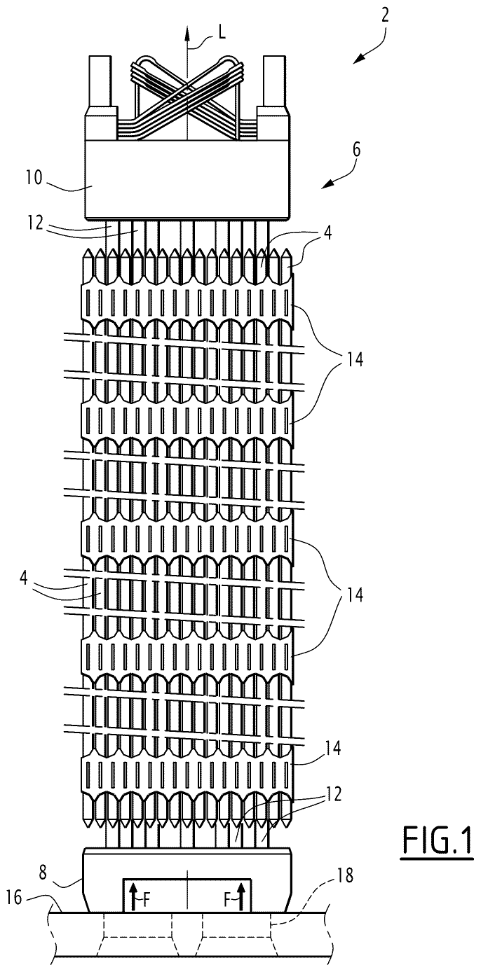

The nuclear fuel assembly 2 of FIG. 1 comprises a bundle of nuclear fuel rods 4 and a support skeleton 6 configured to support the nuclear fuel rods 4.

The nuclear fuel rods 4 extend parallel to each other and to a longitudinal axis L.

The longitudinal axis L extends vertically when the nuclear fuel assembly 2 is placed in a core of a nuclear reactor. In operation, a cooling fluid circulates vertically from the bottom upwards through the nuclear fuel assembly 2 as shown by the arrows F in FIG. 1.

Thereafter in the description, the terms “vertical”, “horizontal”, “top”, “bottom”, “longitudinal”, “transverse”, “upper” and “lower” are understood by reference to the position of the nuclear fuel assembly 2 in the core of the nuclear reactor, the longitudinal axis L being substantially vertical.

The support skeleton 6 comprises a lower end-piece 8, an upper end-piece 10, a plurality of guide tubes 12 and a plurality of spacer grids 14.

The lower end-piece 8 and the upper end-piece 10 are spaced along the longitudinal axis L.

The guide tubes 12 extend along the longitudinal axis L and connect the lower end-piece 8 and the upper end-piece 10 together, maintaining the spacing between the lower end-piece 8 and the upper end-piece 10. The nuclear fuel rods 4 are received between the lower end-piece 8 and the upper end-piece 10.

Each guide tube 12 is open at the upper end thereof to allow the insertion of a control bar (not shown) inside the guide tube 12, through the upper end-piece 10. Such a control rod makes it possible to control the reactivity of the nuclear reactor core wherein the nuclear fuel assembly 2 is inserted.

The spacer grids 14 are distributed along the guide tubes 12 and are spaced apart from one another along the longitudinal axis L. Each spacer grid 14 is rigidly attached to the guide tubes 12, the guide tubes 12 extending through each spacer grid 14.

Each spacer grid 14 is configured to support the nuclear fuel rods 4 by maintaining same in a configuration wherein same are spaced transversely from one another. The nuclear fuel rods 4 are preferably held at the nodes of a substantially regular imaginary network.

As illustrated in FIG. 1, the nuclear fuel assembly 2 is placed on a lower core plate 16 via the lower end-piece 8 thereof, opposite at least one opening 18 for the flow of a cooling fluid.

In operation, the cooling fluid passes through each opening 18, enters the nuclear fuel assembly 2 via the lower end-piece 8, circulates along the nuclear fuel rods 4 and leaves the nuclear fuel assembly 2 via the upper end-piece 10.

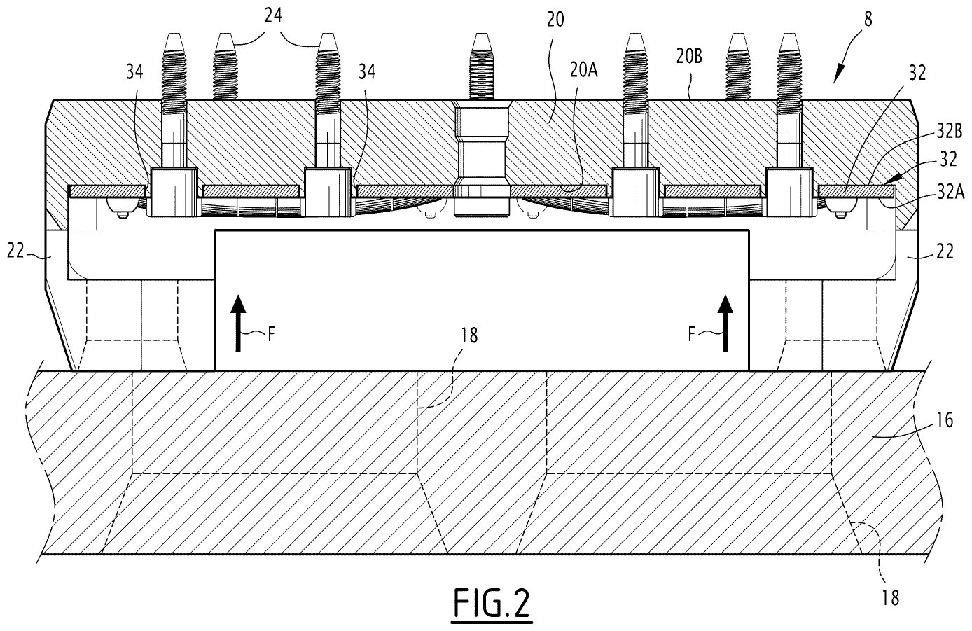

As illustrated in FIG. 2, the lower end-piece 8 comprises e.g. an end-piece plate 20 and feet 22 extending downwards from the end-piece plate 20 so as to bear on the lower core plate 16. The end-piece plate 20 has a lower face 20A and an upper face 20B.

The guide tubes 12 (not shown in FIG. 2) are e.g. attached to the end-piece plate 20 by means of fastening screws 24 passing through the end-piece plate 20.

The lower end-piece 8 is provided with a debris filter 30 configured to filter the cooling fluid.

The debris filter 30 comprises a grid 32. The grid 32 preferably has the shape of a plate.

The grid 32 has at least a first face 32A and a second face 32B.

The grid 32 has a thickness taken between the first face 32A of the grid and the second face 32B of the grid 32.

The first face 32A is intended to be turned downwards, i.e. upstream when considering the direction of flow of the cooling fluid through the grid 32.

The second face 32B is intended to be oriented upwards, i.e. downstream when considering the direction of flow of the cooling fluid through the grid 32.

The grid 32 is arranged under the end-piece plate 20 in such a way that the cooling fluid passes through the grid 32 before passing through the end-piece plate 20.

Preferably, the grid 32 extends over the entire extent of the end-piece plate 20, more particularly the entire extent of the lower face 20A of the end-piece plate 20.

The grid 32 has fastening orifices 34 for the passage of the fastening screws 24.

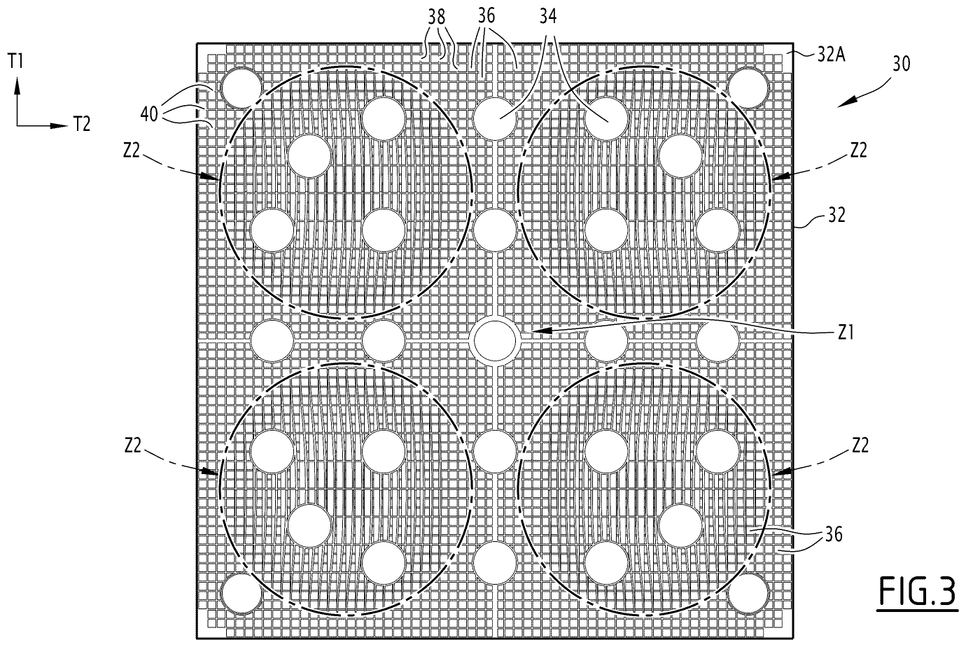

As illustrated in FIG. 3, the grid 32 has passages 36 extending through the grid 32 for the flow of cooling fluid through the grid 32.

The grid 32 is formed e.g. by elongate grid elements 38, 40 which are interlaced.

Each grid element 38, 40 has e.g. the shape of a bar or of an elongate wafer.

Each passage 36 is defined between adjacent interlaced grid elements 38, 40.

More particularly, each passage 36 has e.g. lateral walls defined by two adjacent first grid elements 38 interlaced with two adjacent second grid elements 40.

The grid 32 is e.g. formed by first grid elements 38 extending parallel along a first extension direction T1 and second grid elements 40 extending parallel along a second extension direction T2 perpendicular to the first extension direction T1.

Each passage 36 is delimited between two adjacent first grid elements 38 and two adjacent second grid elements 40.

The grid 32 has e.g. a contour of generally quadrangular shape, more particularly a contour of generally square shape.

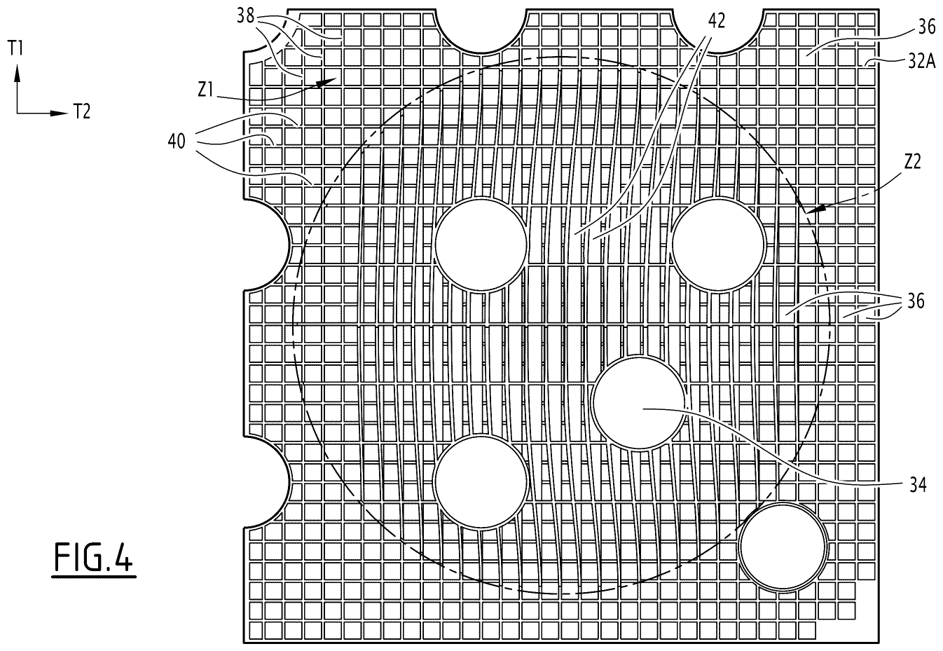

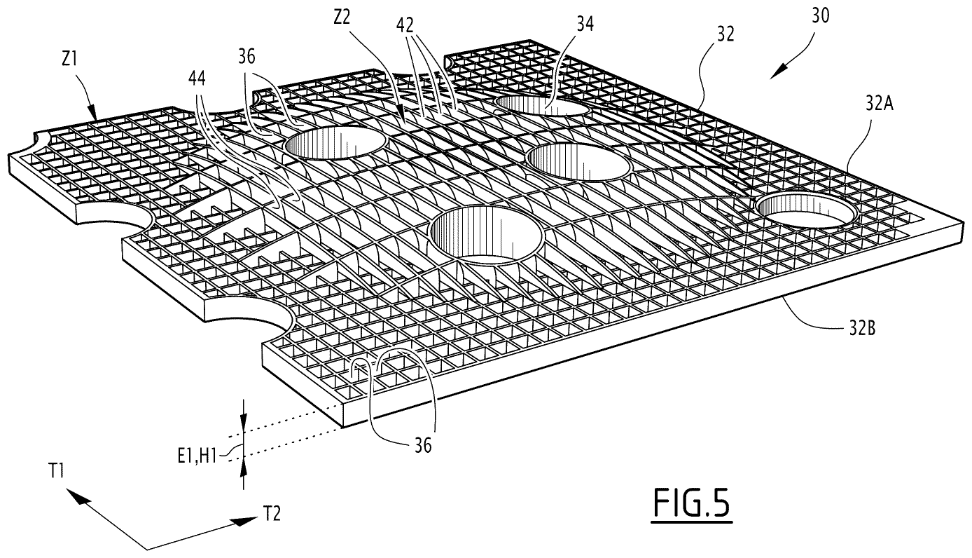

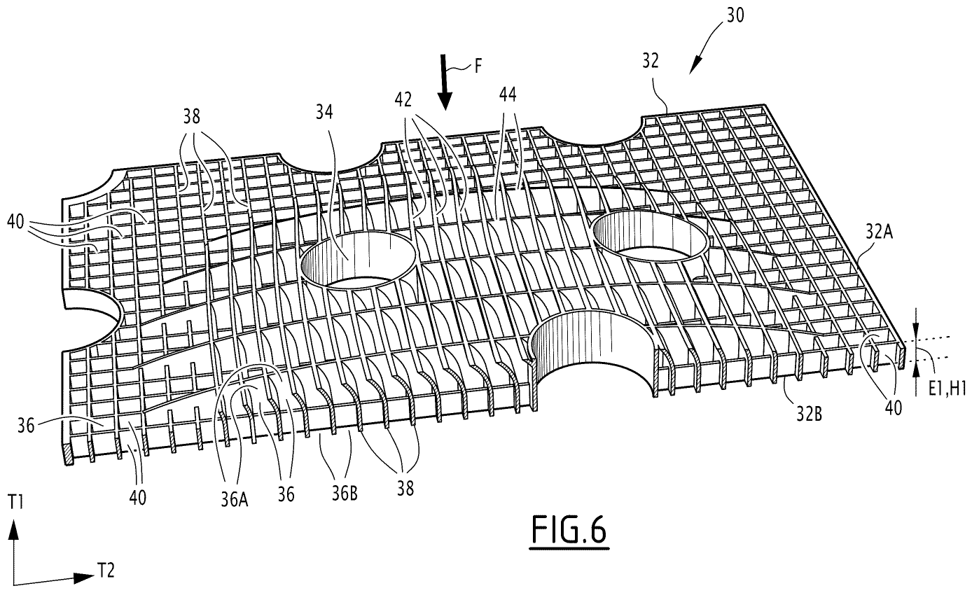

The grid 32 has e.g. four quadrants which are similar, only one quadrant being illustrated in FIGS. 4 to 7, for clarity.

Moreover, in FIGS. 4 to 7, the first face 32A of the grid 32 is oriented upwards, the first face 32A being in practice turned downwards when the grid 32 is mounted on the lower end-piece 8 and the nuclear fuel assembly 2 is installed in the core of the nuclear reactor.

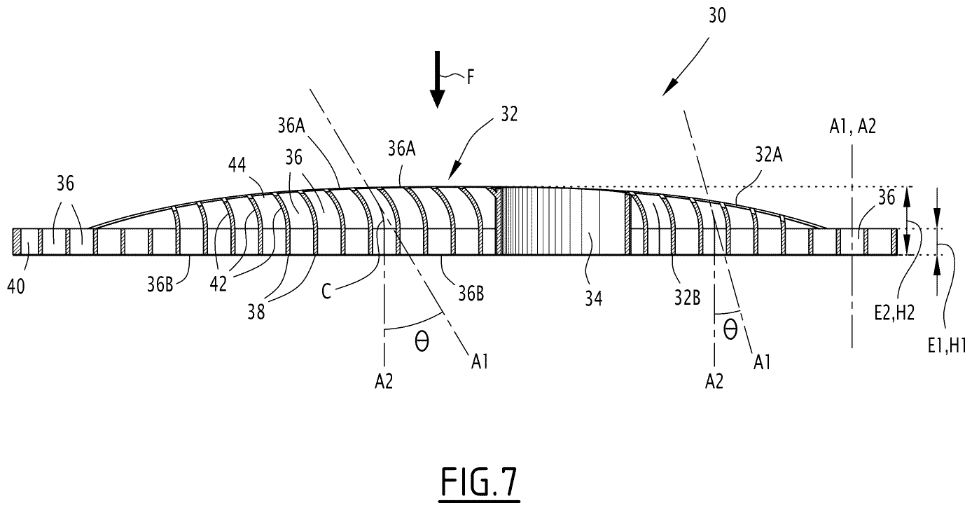

As illustrated in particular in FIG. 7, each passage 36 extends between an inlet 36A, located on the first face 32A, and an outlet 36B, located on the second face 32B.

The inlet 36A of each passage 36 has an inlet axis A1 and the outlet 36B of each passage 36 has an outlet axis A2.

Each passage 36 extends from the inlet 36A thereof to the outlet 36B thereof along a centerline C of the passage 36.

The centerline C of each passage 36 is tangential to the inlet axis A1 at the inlet 36A of the passage 36 and tangential to the outlet axis A2 at the outlet of the passage 36.

The inlet axis A1 and the outlet axis A2 of each passage 36 define therebetween an angle of inclination θ. The angle of inclination θ is also called the deflection angle.

The angle of inclination θ between the inlet axis A1 and the outlet axis A2 of each passage 36 of the grid 32 is comprised e.g. between 0° and 60°.

Each passage 36 having a zero angle of inclination θ (i.e. 0°) corresponds to a rectilinear passage 36. The inlet axis A1 and the outlet axis A2 coincide. The passage 36 has zero deflection between the inlet 36A thereof and the outlet 36B thereof. The inlet 36A and the outlet 36B are aligned Each passage 36 having a non-zero angle of inclination 0 between the inlet axis A1 thereof and the outlet axis A2 thereof has a non-zero deflection between the inlet 36A thereof and the outlet 36B thereof.

A non-zero angle of inclination θ corresponds to a curved passage 36, i.e. extending along a curved centerline C. The centerline C of each curved passage 36 preferably has an inclination varying monotonically between the inlet axis A1 and the outlet axis A2.

Each passage 36 having a non-zero angle of inclination θ between the inlet axis A1 thereof and the outlet axis A2 thereof preferably has the inlet 36A thereof and the outlet 36B thereof offset transversely with respect to each other when considering the direction of flow of the fluid through the grid 32.

Advantageously, the grid 32 has passages 36 having different angles of inclination e between the inlet axis A1 thereof and the outlet axis A2 thereof. In other words, the grid 32 has passages 36 having different respective deflections.

In FIG. 7, three different angles of inclination θ are shown, one of which is zero (to the right in FIG. 7) and which corresponds to a rectilinear passage 36.

In one embodiment, the outlet axes A2 of all the passages 36 are parallel to each other, the inlet axes A1 of passages 36 having different angles of inclination θ being inclined relative to each other.

Preferably, the outlet axes A2 of the passages 36 are parallel to the direction of flow of the fluid. Thereof makes it possible to limit disturbances in the flow of the fluid at the outlet of the grid 32.

The provision of passages 36 with different angles of inclination θ makes it possible to differentiate the retention capacity and the flow resistance of different zones of the grid 32.

A zone of the grid with passages 36 having larger angles of inclination θ (i.e. larger deflections) has a greater debris retention capacity and greater flow resistance, while a zone of the grid with passages 36 having smaller angles of inclination θ (i.e. smaller deflections) has a smaller debris retention capacity and a smaller flow resistance.

Preferably, the grid 32 has a first zone Z1, the first zone Z1 having a plurality of passages 36, and at least one second zone Z2, each second zone Z2 having a plurality of passages 36, the angles of inclination θ of the passages 36 situated in each second zone Z2 being non-zero and greater than or equal to the maximum angle of inclination θ of the passages 36 situated in the first zone Z1.

More particularly, the outlet axes A2 of the passages 36 of the first zone Z1 and of each second zone Z2 are e.g. parallel to each other.

The inlet axes A1 of passages 36 of each second zone Z2 are e.g. inclined by a non-zero angle with respect to the inlet axes A1 of passages 36 of the first zone Z1. The inlet axes A1 of the passages 36 of each second zone Z2 form a non-zero angle with the inlet axes A1 of the passages 36 of the first zone Z1.

The angle of inclination θ between the inlet axis A1 and the outlet axis A2 of each passage 36 of the first zone Z1 is e.g. substantially zero. The passages 36 of the first zone Z1 are e.g. rectilinear.

Preferably, the grid 32 has a respective second zone Z2 associated with each opening 18 of the lower core plate 16 situated under the lower end-piece 8 when the nuclear fuel assembly 2 is arranged on the lower core plate 16.

The grid 32 has e.g. four second zones Z2 distributed over the grid 32 of quadrangular shape and more particularly square shape, the second zones Z2 being distributed e.g. according to a 2×2 matrix distribution.

The grid 32 has herein four second zones Z2, each second zone Z2 being situated in a respective quadrant of the grid 32.

The grid 32 has e.g. a variable thickness, the thickness of the grid 32 in each second zone Z2 being strictly greater than the thickness of the grid in the first zone Z1.

As illustrated in FIGS. 4 to 7, and more particularly in FIG. 7, in each second zone Z2, the grid 32 has a thickness strictly greater than the thickness of the grid 32 in the first zone Z1.

Preferably, in the first zone Z1, the grid 32 has a substantially constant thickness, called the first thickness E1.

The height of each grid element 38, 40 is taken according to the thickness of the grid 32.

In the first zone Z1, each grid element 38, 40 has a substantially constant height or first height H1. The first height H1 corresponds to the first thickness E1.

In each second zone Z2, the grid 32 has a second thickness E2 strictly greater than the first thickness E1 of the grid 32.

The grid 32 has e. g, a variable thickness, varying between the first thickness E1 at the periphery of each second zone Z2 up to a second thickness E2, e.g. at the center of the second zone Z2.

In each second zone Z2, at least part of the grid elements 38, 40 have a height strictly greater than the first height H1.

At least part of the grid elements 38, 40 has e.g. a variable height, varying e.g. between the first height H1 and a second height H2.

The first height H1 corresponds to the first thickness E1 and the second height H2 corresponds to the second thickness E2.

For example, in each second zone Z2, each grid element 38, 40 has a height greater than the first height H1 or only a portion of the grid elements 38, 40 has a height greater than the first height H1.

More particularly, in each second zone Z2, each first grid element 38 or only a part of the grid elements 38 has a height greater than the first height H1 and/or each second grid element 40 or only a part of the second grid elements 40 has a height greater than the first height H1.

In FIGS. 4 to 7, in each second zone Z2, each first grid element 38 has a height greater than the first height H1 and every third second grid element 40 has a height greater than the first height H1.

The lateral walls of each passage 36 are defined by the portions of the grid elements 38, 40 delimiting the passage 36.

Thereby, lateral walls of the passages located in each second zone Z2 are higher than the lateral walls of the passages located in the first zone Z1.

As illustrated in particular in FIG. 7, each passage 36 is delimited between two opposite lateral walls which extend substantially parallel while being curved Thereby, each of the passages 36 extends curvilinearly, the inlet 36A and the outlet 36B thereof, being offset transversely with respect to each other and inclined with respect to each other.

More particularly, in each second zone Z2, each first grid element 38 of variable height, and in particular each first grid element 38, has an upper portion 42 which extends higher than the rest of the first face 32A of the grid 32 in the first zone Z1.

The upper portion 42 of each first grid element 38 is e.g. curved to define the curved passages 36.

Each of the second grid elements 40 extends e.g. substantially along a plane.

In each second zone Z2, second grid elements 40 of variable height have upper portions 44 which cross the upper portions 42 of the first grid elements 38 of variable height.

The grid 30 is e.g. produced by a manufacturing method by adding material (additive manufacturing) and/or by a manufacturing method by removing material (machining).

In order to obtain the grid 32 with passages 36 having inlet axes A1 inclined with respect to one another and outlet axes A2 parallel to one another, a grid blank 32 is e.g. manufactured initially with a constant thickness, each passage 36 extending along a curved centerline C with a non-zero angle of inclination between the inlet axis A1 and the outlet axis A2 thereof, the passages 36 extending parallel to one another.

Initially, the inlet axes A1 of the passages 36 are parallel to each other and the outlet axes A2 of the passages 36 are parallel to each other.

The grid blank 32 is then machined on the first face 32A so as to form the first zone Z1 and each second zone Z2.

Because of the variation in thickness of the machined grid 32, some passages 36 are reduced in height, and passages 36 finally have inlet axes A1 inclined with respect to one another.

More particularly, the passages 36 located in the thinnest regions of the machined grid 32 have the least inclined inlet axes A1 and the smallest angles of inclination θ, and the passages 36 located in the thickest regions of the grid 32 have the most inclined inlet axes A1 and the largest angles of inclination θ.

Thereby, passages 36 situated in each second zone Z2 have a greater angle of inclination θ than passages 36 situated in the first zone Z1.

The thickness of the grid 32 is e.g. reduced in the first zone Z1 in such a way that only a rectilinear outlet portion 36 of the grid 32 remains in each passage 36 of the first zone Z1 before machining, each passage 36 of the first zone Z1 being thus rectilinear in the machined grid 32.

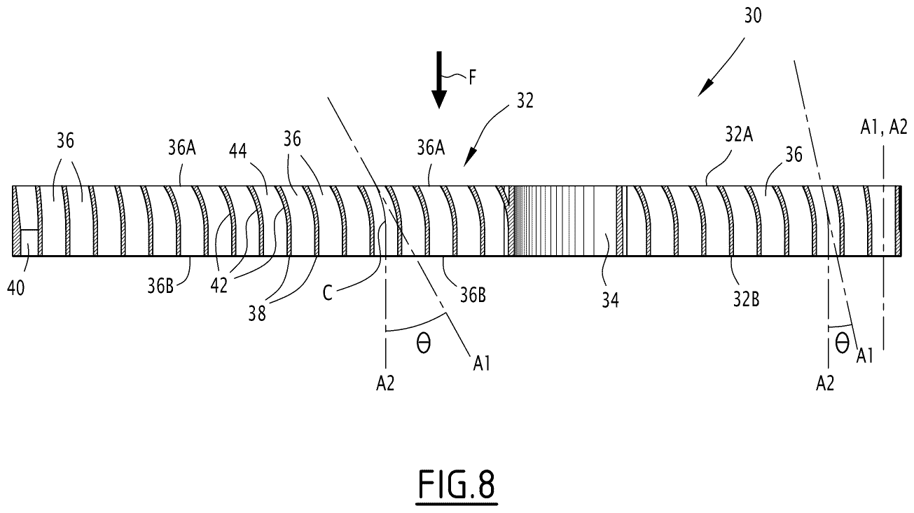

In a variant illustrated in FIG. 8, which is similar to FIG. 7 and wherein the numerical references to analogous elements are repeated, a grid 32 has e.g. a constant thickness, the differences in inclination between the passages 36 resulting from differences in curvature between the centerlines C of the passages 36, e.g. differences in curvature between the lateral walls of the passages 36.

Such a grid 32 is obtained e.g. by additive manufacturing.

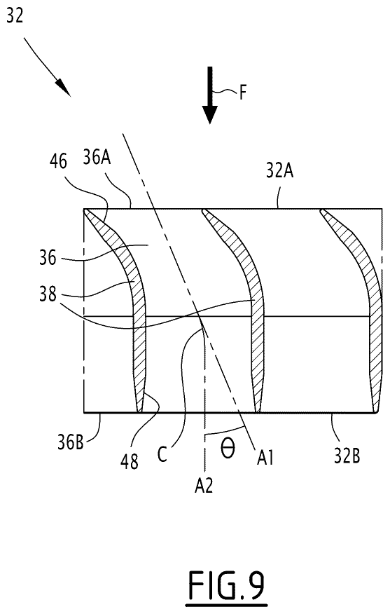

As illustrated in FIG. 9, it is possible to provide passages 36 of variable cross-section along the passage 36, each passage 36 of variable cross-section having a converging inlet section (when considering the direction of flow of the fluid in the passage 36 from the inlet 36A to the outlet 36B) and/or a diverging outlet section 48.

A converging inlet section 46 or a diverging outlet section 48 is obtained e.g. by providing a chamfer on the lateral walls of the inlet section 46 and the outlet section respectively.

Each passage 36 of variable cross-section is provided with a converging inlet section 46 and a diverging outlet section 48, with or without an intermediate section of constant cross-section, a converging inlet section 46, the remainder of the passage having a constant cross-section or a diverging outlet section 46, the remainder of the passage having a constant cross-section.

A passage 36 of variable cross-section provided with a converging inlet section 46 and a diverging outlet section 48 without an intermediate section of constant cross-section has e.g. curved and convex lateral walls.

The variation in cross-section of passage 36 makes it possible to generate a venturi effect in the fluid circulating in the passage 36.

As also illustrated in FIG. 9, preferably the lower edge and/or the upper edge of each side wall of each passage 36 is preferably rounded. Thereof makes it possible to enhance the flow of the fluid by limiting the flow resistance of the grid 32.

The provision of passage 36 with different angles of inclination θ between the inlet 36A and the outlet 36B makes it possible to differentiate the retention capacity and the flow resistance of different zones of the grid 32.

A zone of the grid with passages 36 having larger angles of inclination θ has a greater debris retention capacity and greater flow resistance, while a zone of the grid with passages 36 having smaller angles of inclination θ has a smaller debris retention capacity and a smaller flow resistance.

The provision of a first zone Z1 with a first thickness E1 and of one or a plurality of second zones Z2 with a thickness strictly greater than the first thickness E1 makes it possible to easily form passages 36 with angles of inclination θ between the inlet 36A and the outlet 36B smaller than the first zone Z1 and passages 36 with angles of inclination θ between the inlet 36A and the outlet 36B larger in each second zone Z2, from a grid workpiece blank of constant thickness, the passages 36 being parallel with angles of inclination θ between the inlet 36A and the outlet 36B identical and non-zero.

The second zone or zones Z2 can be placed on the grid 30 at the location or locations where the probability of debris passing is greatest, which is most of the time opposite the openings 18 of the lower core plate 16 through which the cooling fluid arrives under the nuclear fuel assemblies 2.

Thereby, it is possible to obtain a grid 30 having limited hydraulic resistance while having a satisfactory debris retention capacity.

The grid 30 can be manufactured easily, e.g. by additive manufacturing and/or by machining.

The present disclosure is not limited to the example and variants described hereinabove, other examples and variants being conceivable.

The passages 36 of the grid of FIGS. 4 and 7 are delimited between curved first grid elements 38 and flat second grid elements 40, so that the inlet axes A1 of the passages 36 are all inclined along the same direction. The inlet axes A1 of the passages 36 are all parallel to the same reference plane. The inlet axes A1 may be parallel if the angles of inclination of passages 36 are either the same or not the same if passages have different angles of inclination.

Of course, in a variant, the inlet axes A1 of the passages 36 can be inclined along different directions. To this end, it is possible to provide for the second grid elements 40 to also be curved.

Moreover, it is possible to provide outlet axes A2 which are not parallel to each other, with moreover outlet axes A2 which have a non-zero inclination with respect to the longitudinal axis L of the nuclear fuel assembly 2 when the grid 30 is mounted on the lower end-piece 8.

More particularly, it is possible to provide for the inlet axes A1 to be parallel to each other and for the outlet axes A2 to be inclined with respect to each other in order to obtain different angles of inclination, the outlet axes A2 being e.g. all parallel to the same reference plane or inclined along different directions.

The provision of a first zone Z1 having a first thickness E1 and of at least one second zone Z2 having a second thickness E2 is advantageous independently of the fact that the passages 36 have angles of inclination that are non-zero between an inlet axis A1 and an outlet axis A2, more particularly differentiated angles of inclination between different passages 36.

Thus, according to another aspect, the present disclosure proposes a debris filter for a lower end-piece of a nuclear fuel assembly, the debris filter being formed by a grid 32 having a first face 32A and an opposite second face 32B, the grid 32 having passages 36 extending between an inlet 36A on the first face 32A and an outlet 36B on the second face 32B for the flow of a cooling fluid through the grid 32, the grid 32 having a first zone Z1 and at least one second zone Z2 wherein the grid 32 has a thickness greater than the thickness of the plate in the first zone Z1, passages 36 being present in the first zone Z1 and in each second zone Z2.

Each second zone Z2 thicker than the first zone Z1 has a higher retention capacity than the first zone Z1 and a higher flow resistance than the first zone Z1.

The passages 36 situated in each second zone Z2 are a priori longer than the passages 36 situated in the second zone Z2, and make it possible e.g. to filter longer debris.

The provision of a first zone Z1 and at least one second zone Z2 thicker than the first zone Z1 makes it possible to locally adapt the retention capacity, depending on the probability of the presence of debris, while limiting the flow resistance of the grid 32 as a whole.

Such a grid with a first zone Z1 and at least one second zone Z2 with different thicknesses can be provided with rectilinear passages 36 and/or curved passages 36, and more particularly with passages 36 all rectilinear or all curved, the curved passages 36 having either identical or differentiated angles of inclination.

The features discussed in relation to the embodiment shown in FIGS. 4 to 7 may be provided as an option on the grid 32.

More particularly, in embodiments, the grid 32 comprises one or a plurality of the following optional features, taken individually or in all technically possible combinations:
each second zone Z2 has passages 36 with an inlet 36A and an outlet 36B offset transversely with respect to each other;
each second zone Z2 has passages 36 having an inlet 36A and an outlet 36B inclined with respect to each other with a non-zero angle of inclination.
each second zone Z2 has passages 36 extending in a non-rectilinear manner;
the grid 32 has, in each second zone Z2, an increasing thickness from the periphery of the second zone Z2 toward the center of the second zone Z2;
each second zone Z2 has a circular contour.
at least one passage 36 situated in a second zone Z2 is delimited between two opposite curved lateral walls;
the grid 32 is formed of interlaced grid elements 38, 40 between which the passages 36 are delimited, including at least one grid element 38, 40 of variable height extending in the first zone Z1 and at least one second zone Z2, the height of each grid element 38, 40 of variable height being greater in each second zone Z2 crossed by the grid element 38, 40 of variable height and smaller in the first zone Z1;
the grid 32 has a quadrangular contour, more particularly a square contour;
the grid 32 has four second zones Z2;
the second zones Z2 are distributed on the grid 32 as a matrix;

According to said other aspect, the present disclosure also proposes a lower end-piece for a nuclear fuel assembly equipped with a debris filter as defined herein above and/or a nuclear fuel assembly, more particularly for a pressurized water nuclear reactor, comprising a debris filter as defined hereinabove.

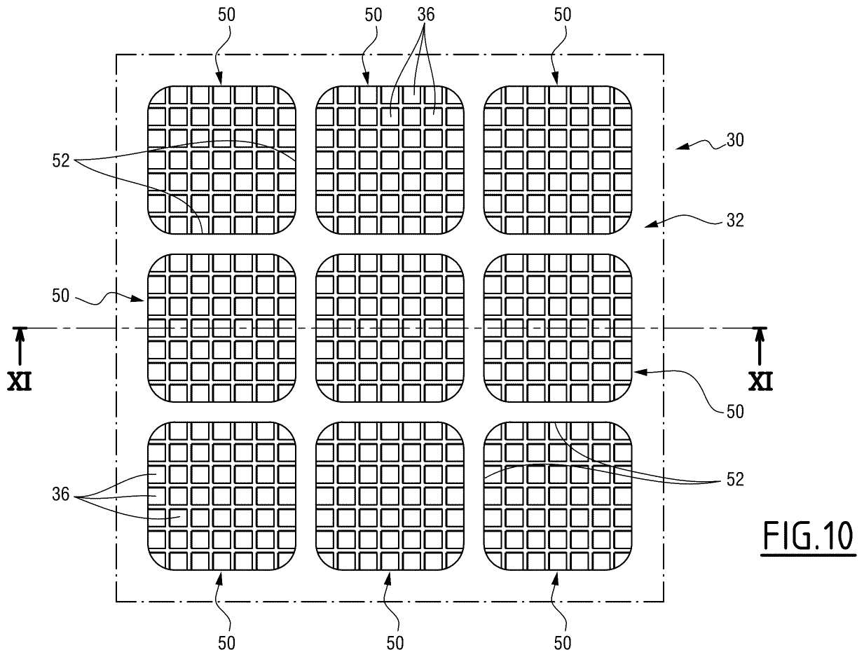

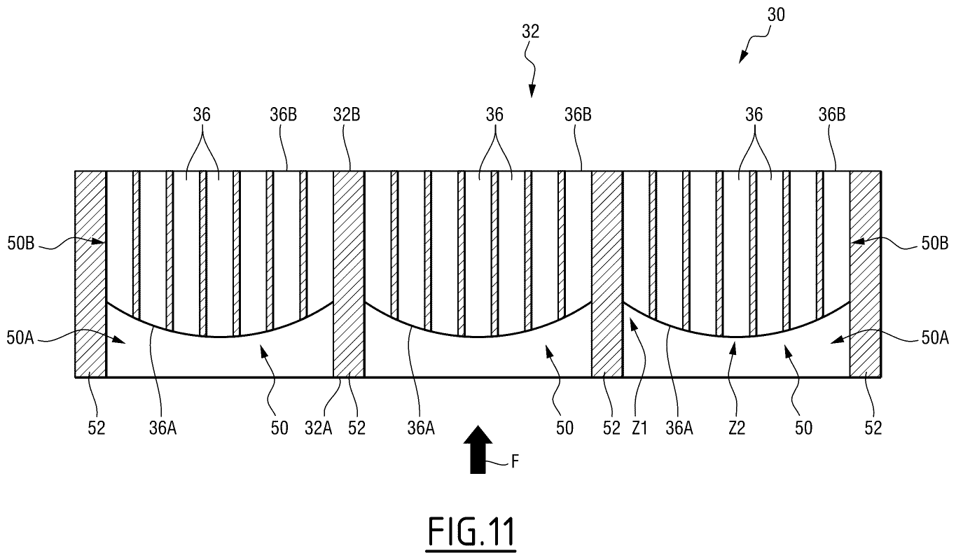

The grid 32 of the debris filter 30 illustrated in FIGS. 10 and 11 comprises a plurality of cells 50 separated by partitions 52. Each cell 50 crosses through the grid 32. Each cell 50 extends between the first face 32A of the grid 32 and the second face 32B of the grid 32. Each cell 50 permits the flow of the fluid through the grid 32, as illustrated by the arrow F in FIG. 11.

The grid 32 has, in each cell 50, a plurality of separate passages 36. The passages 36 of each cell 50 are separated from one another by lateral walls or separation walls 54, which are e.g. interlaced grid elements.

The grid 32 has a plurality of cells 50, the number of cells 50 preferably being equal to or greater than five. The cells 50 are e.g. distributed on the grid 32 in a matrix distribution.

The partitions 52 are e.g. higher than the passages 36 and/or than the separation walls 54.

Each cell 50 has a first empty section 50A (FIG. 11) and a second section 50B (FIG. 11) wherein the passages 36 are delimited, i.e. through which the separation walls 54 extend.

The first section 50A is e.g. adjacent to the first face 32A of the grid 32, the second section 50B being adjacent to the second face 32B of the grid 32. The first section 50A is preferably situated upstream of the second section 50B, considering the direction of circulation of the fluid through the grid 32.

In one or a plurality of cells 50, and more particularly in each cell 50, the grid 32 has a variable thickness, with more particularly a first zone Z1 that is thinner and a second zone Z2 wherein the grid 32 has a thicker thickness.

In each cell 50, wherein the grid 32 has a variable thickness, the first zone Z1 has a thickness strictly less than the thickness of the second zone Z2.

Each cell 50, wherein the grid 32 has a variable thickness, comprises passages 36 of different heights. The cell 50 comprises more particularly passages 36 which have lower height, situated in the first zone Z1, and passages 36 which are higher, situated in the second zone Z2.

In each cell 50, wherein the grid 32 has a variable thickness, the first zone Z1 is e.g. a peripheral zone of the cell 50, the second zone Z2 being a central zone of the cell 50.

In each cell 50, wherein the grid 32 has a variable thickness, the grid 32 is e.g. not flat on the side of the first face 32A and flat on the side of the second face 32B.

When same is not flat, the first face 32A has e.g. a general convex shape. The first face 32A is e.g. in the general shape of a spherical cap protruding from the side of the first face 32A.

The grid 32 having cells 50 separated by partitions 52 with a plurality of separate passages 36 delimited in each cell 50, more particularly passages 36 of different heights, e.g. because of the variable height of the grid 32, leads to efficient filtering of the debris.

As illustrated in FIG. 11, in one or a plurality of cells 50, and more particularly in each cell 50, each passage 36 is e.g. rectilinear. The inlet 36A and the outlet 36B of each rectilinear passage are aligned and coaxial.

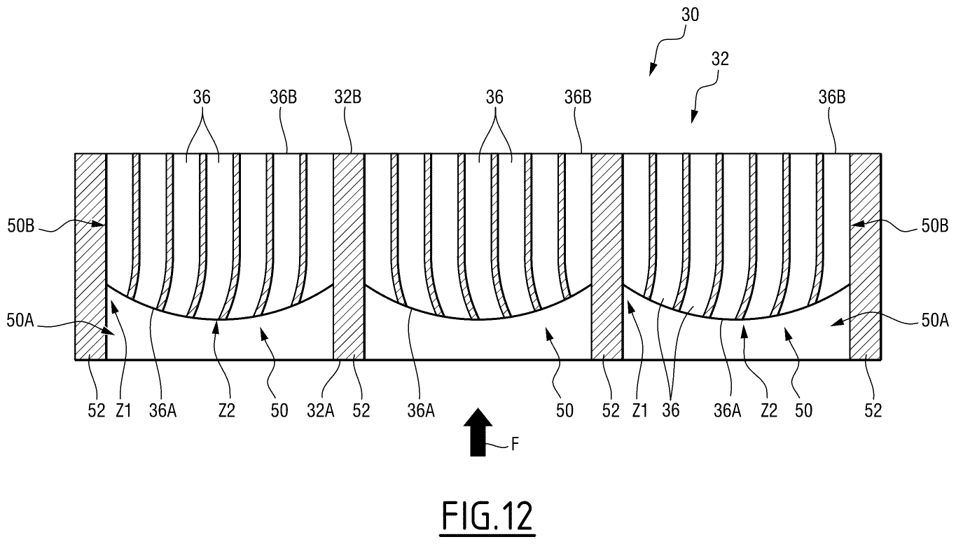

In a variant, as illustrated in FIG. 12, in at least one cell 50, and more particularly in each cell 50, passages 36 of the cell 50 have a non-zero deflection between the inlet 36A and the outlet 36B of the passage(s) 36.

The grid 32 preferably comprises passages 36 which have different deflections. In examples of embodiments, in at least one cell, passages of the cell 50 have different deflections.

What is claimed is:

1-20. (canceled)

21: A debris filter for a lower end-piece of nuclear fuel assembly, the debris filter comprising:
a grid having a first face and an opposite second face, the grid having passages extending between an inlet on the first face and an outlet on the second face for a flow of a cooling fluid through the grid, the grid having a first zone and at least one second zone wherein the grid has a thickness greater than the thickness of the grid in the first zone, the passages being present in the first zone and in each second zone.

22: The debris filter according to claim 21, wherein the passages present in each second zone have an inlet and an outlet offset transversely with respect to each other.

23: The debris filter according to claim 21, wherein the passages present in each second zone have an inlet and an outlet inclined relative to each other at a non-zero angle of inclination.

24: The debris filter according to claim 21, wherein the passages present in each second zone extend in a non-rectilinear manner.

25: The debris filter according to claim 21, wherein the grid has in each second zone a thickness increasing from a periphery of the second zone toward a center of the second zone.

26: The debris filter according to claim 21, wherein each second zone has a circular contour.

27: The debris filter according to claim 21, wherein lateral walls of the passages located in each second zone are higher than lateral walls of the passages located in the first zone.

28: The debris filter according to claim 21, wherein at least one passage in a second region is defined between two opposite curved lateral walls.

29: The debris filter according to claim 21, wherein the grid is formed of interlaced grid elements between which the passages are delimited, including at least one grid element of variable height extending in the first zone and at least one second zone, a height of each grid element of variable height being greater in each second zone crossed by the grid element of variable height and smaller in the first zone.

30: The debris filter according to claim 21, wherein the grid has a quadrangular contour or a square contour.

31: The debris filter according to claim 21, wherein the grid has four second zones or at least five second zones.

32: The debris filter according to claim 21, wherein the second zones are distributed over the grid as a matrix.

33: The debris filter according to claim 21, wherein the grid comprises a plurality of cells separated by partitions, each cell containing a plurality of separate passages delimited by lateral walls.

34: The debris filter according to claim 33, wherein each cell contains a first zone and/or a second zone.

35: The debris filter according to claim 33, wherein the partitions of each cell are strictly higher than the passages provided in the cell.

36: The debris filter according to claim 33, wherein each cell comprises a first section and a second section wherein the passages are located.

37: The debris filter according to claim 33, wherein in each cell the first face of the grid is generally not flat and/or the second face of the grid is flat.

38: The debris filter according to claim 33, wherein the grid comprises at least five cells and/or the cells are distributed as a matrix on the grid.

39: A lower end-piece of nuclear fuel assembly comprising the debris filter as recited in claim 21.

40: A nuclear fuel assembly comprising the debris filter as recited in claim 21.
